(19) United States
(12) Patent Application Publication
(10) Pub. No.: US 2008/0211225 A1
(43) Pub. Date: Sep. 4, 2008

(54) Method and apparatus for printing multiple pages

(76) Inventors: David Pirie, Marlborough, CT (US); David J. Loos, Gaithersburg, MD (US)

Correspondence Address: PEPE & HAZARD, LLP, 225 ASYLUM ST., HARTFORD, CT, 06103, US

(21) Appl. No.: 11/713,360

(22) Filed: Mar. 2, 2007

(51) Int. Cl. B42D 5/00

(52) U.S. Cl. 283/72

(57) ABSTRACT

A method for imprinting documents imprints visible printed matter on multiple pages of imprintable material and including visible control indicia in one of the marginal portions. The visible control indicia are scanned and data is transmitted to a computer which then imprints on the pages in invisible ink invisible control indicia associated with the visible control indicia. Subsequently, an energy source is applied to the invisible control indicia to render the control indicia discernable to a scanner. The discernable control indicia is scanned to generate data sent to a computer where it is compared with information stored in the computer to determine that the pages conform to stored parameters. Further operations on the pages in which the invisible control indicia are activated may be conducted by reading the data in the invisible control indicia.

### BACKGROUND OF THE INVENTION

The present invention relates to printing apparatus and, more particularly, to a printing installation in which there is included means for verifying that multiple page documents are provided in accordance with stored instructions.

Many companies employ large volume mailings of multiple page documents and frequently include variations in the text or customization such as the salutation and address. To ensure that the assembled documents are in proper sequence, barcodes or other indicia are imprinted on the documents to enable visual review. Although this can be done by an individual, high volumes require automatic scanning and comparison with stored data. Barcode readers or visual scanners (OCR) are used to read control indicia and generate signals or images which are compared with stored data in a computer to ensure that the documents are in proper sequence and/or contain the proper printed matter.

However, most companies do not wish to have highly visible barcodes or the like since that depersonalizes the mailing. As a result, some mailings use small and/or faint marks which are positioned in less conspicuous locations. Although invisible text and marks have heretofore been imprinted in documents, they have not been used for controlling document assembling installations and other processing steps.

When a continuous web is two or more pages in width, pages with different printed matters may be printed on each page, and, at the cutting station, similarly printed pages may be conveyed to an assembly or collating station where they are “stacked” in the desired sequence to provide a multipage document.

The term “page” as used herein when referring to the web refers to individual pages or portions of a continuous web which, when passed through a cutting station, is cut and trimmed into individual pages. Thus, a web having a 39 inch width may have four pages when imprinted.

The terms “energy source”, and “activation” and “activating” as used herein refer to the action of infrared or ultraviolet light acting to make the ink of the invisible control indicia visible to a scanner or OCR.

The terms “discernable” and “discernable to a scanner” refer to the action of the energy source to render the invisible indicia readable by a cooperating scanner to provide data for transmission to a computer.

The term “invisible” means not discernable to the naked human eye”.

The terms “scanning” and “scanner” include any form of capturing an image to generate discerned data from the image.

It is an object of the present invention to provide a novel method for imprinting multi-page documents with invisible indicia which may be read upon application thereto of an activating energy source to ensure that the printed pages are in the proper sequence.

It is also an object to provide such a printing method which can be operated at high speed in several stations.

Another object is to provide a novel method for imprinting pages with an invisible ink which is readily and safely activated by an appropriate energy source to enable reading of the control indicia.

A further object is to provide a novel printing and document assembling installation for printing invisible control indicia to ensure that multiple pages are correctly assembled.

### SUMMARY OF THE INVENTION

It has now been found that the foregoing and related objects may be readily attained in a method for imprinting documents in which visible printed matter is printed on multiple pages of imprintable material. The printed matter is bounded by marginal portions of the pages. In addition to the printed matter, there is imprinted visible control indicia in one of the marginal portions. The visible control indicia are scanned and the data transmitted to a computer. Using an invisible ink, there is imprinted on the pages invisible control indicia associated with the visible control indicia.

An energy source is applied to the invisible control indicia to render the control indicia discernable to a scanner. The discernable control indicia is scanned to generate and transmit scanned data to a computer. The transmitted data from the discernable control indicia is compared with information stored in the computer to determine that the pages conform to stored parameters.

A marginal portion of the pages is trimmed to remove the visible control indicia while retaining the invisible control indicia. Further operations are conducted on the pages in which the invisible control indicia are activated by an energy source, scanned, and, based upon the scanned data, the pages are subjected to additional processing steps.

In one embodiment, the imprintable material may be a continuous web dimensioned to provide a multiplicity of pages across the web, and the web is cut into individual pages. The cutting step may be concurrent with the trimming step. The imprintable material is usually paper.

The invisible control indicia may include additional data for use in subsequent processing of the pages. During additional processing, the invisible control indicia may be scanned to control processing of the pages and ensure compliance with desired quality control parameters.

The energy source may be infrared or ultraviolet light and wherein the ink is rendered discernable thereby. In some embodiments there is included additional data in the invisible control indicia. The initial printing step may print registration marks in the marginal portions to actuate the scanner when the control indicia are positioned thereunder. In one embodiment of the process, the cut pages are collated into multipage documents.

The method of the present invention is conveniently conducted in apparatus including a printer for imprinting visible printed matter on the pages of the imprintable material. The printed matter on each page are bounded by marginal portions, and the printer prints visible control indicia in a marginal portion of the pages. A scanner is provided to scan the visible control indicia and transmit the data from the scanned indicia to a computer. A second printer imprints at least some of the pages with invisible control indicia associated with the visible control indicia.

Subsequently, an energy source rendering the invisible control indicia discernable, and a scanner scans the discernable control data and comprises the data with data stored in a computer to ensure that the pages conform to stored parameters.

A cutter station trims the pages to remove the marginal portion including the visible control indicia, and an assembler station gathers the printed pages. An energy source is provided to render discernable the invisible control indicia, and a scanner scans the visible control indicia made discernable by the energy source and transmits the scanned data to a computer which receives the scanned data and compares the data with data stored therein. The computer then effects operation of subsequent actions at processing stations.

### BRIEF DESCRIPTION OF THE ATTACHED DRAWING

FIG. 1 is a schematic fragmentary illustration of a portion of an imprintable web which has been imprinted in accordance with the present invention;

FIG. 2 is a schematic illustration of a pair of pages imprinted in accordance with the present invention; and

FIG. 3 is a schematic illustration of a printing and assembling installation for practicing the method of the present invention.

### DETAILED DESCRIPTION OF THE ILLUSTRATED EMBODIMENT

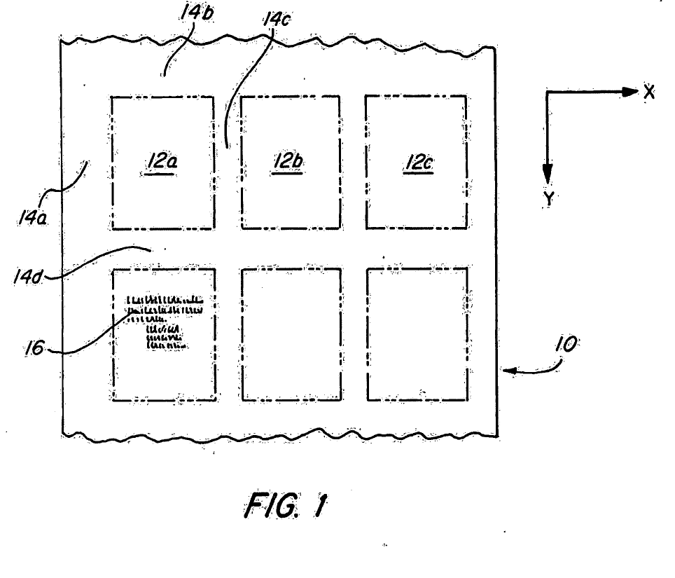

Turning first to FIG. 1, therein schematically illustrated is a web of imprintable material generally designated by the numeral 10 which is of a width dimension in the X-axis, to provide three pages 12a, 12b, 12c when cut, each page having side marginal portions 14, 15, and spaced marginal portions 18, 20 along the Y-axis. The pages 12 of this web 10 are imprinted with text 22 which may vary from page to page.

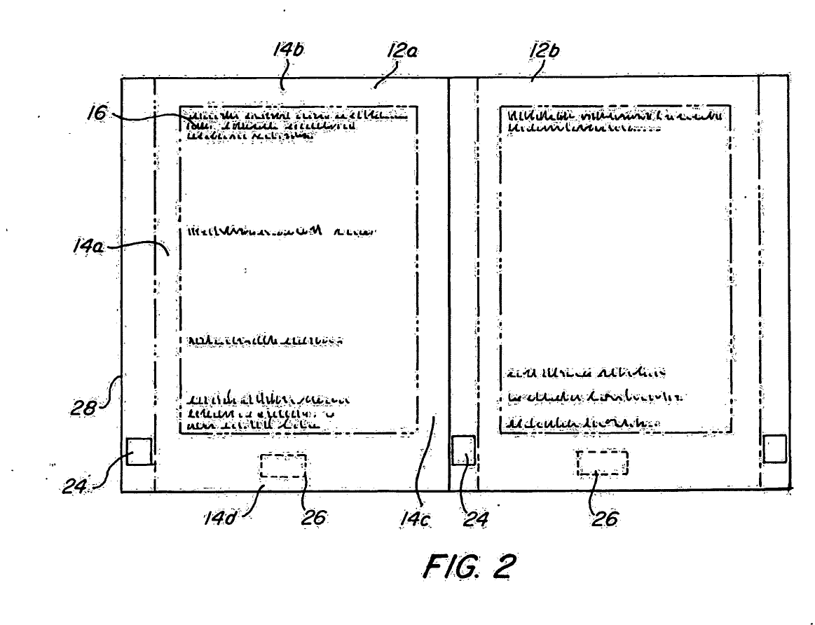

Turning next to FIG. 2, therein illustrated is a pair of side by side pages 12a, 12b, which have text 16 imprinted thereon and visible control indicia 24 imprinted on the left side marginal portions 14a, 14c and invisible control indicia 26 in the top/bottom marginal portions 14b, 14d. The marginal portion 14a of the web along the side edge 28 is generally wider than that between interior edges of the pages and may have perforations therein to enable driving action on the web 10 by pins (not shown) on drive sprockets (not shown). When the web 10 is passed through the cutting station, it is cut along both axes to produce the individual pages 12 with marginal portions extending about the text 16. The visible control indicia 24 are in the side trim portion and the invisible indicia are in the bottom/top marginal portions.

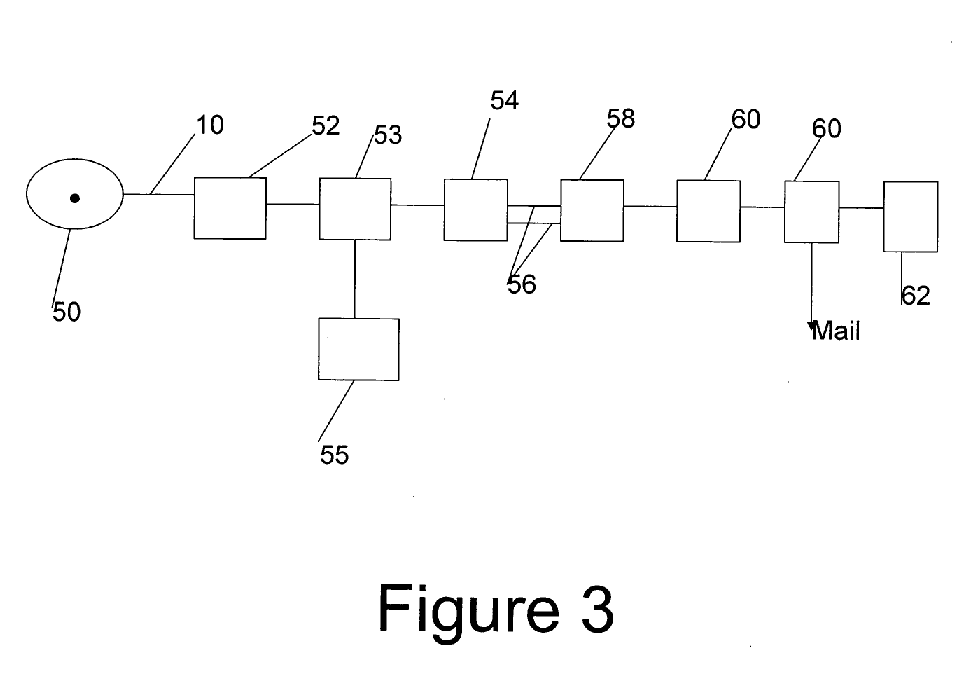

Turning next to FIG. 3, therein schematically illustrated is a printing installation in accordance with the present invention. A printable web 10 is drawn from a roll 50 and conveyed through a printing station 52 in which the printed matter, including the visible control indicia, is imprinted thereon. The printed web then passes through the station 53 with whereby the visible indicia is scanned, compared with data in computer 55 and an invisible indicia is printed and then scanned and compared with data stored in computer 55. The printed web is then passed through a cutting station 54 to produce streams of similarly printed individual pages 56 and trim the marginal portion having the visible control indicia imprinted therein.

Several streams of pages may be passed to a collator 58 in which they are assembled into sets which are then passed through a verifier station 60 in which the movable control indicia are illuminated with infrared or ultraviolet light, and a scanner reads the control indicia and transmits the data to a computer 62 which compares the transmitted data with the stored data to ensure that the pages have been properly assembled.

The assembled and verified set of the pages may then be inserted into envelopes for mailing.

In a preferred embodiment, there are two separate printers employed, one of which imprints the text and the visible control indicia in the side margin, both in visible ink. A second printer then applies invisible ink to produce invisible control indicia in any appropriate location on the page. The second printer is coupled to a scanner which reads the barcode or other form of visible control indicia in the side margin, and the computer sends instructions to the second printer to print all or some of the control indicia in invisible ink. <Alternatively, the second printer may receive its instructions directly from the computer so as to replicate the control indicia in the side margin as invisible indicia on the bottom marginal portions>. By imprinting the invisible control indicia in the side margin, the cutting operation will remove the portion bearing the visible control indicia.

The invisible control indicia can be located at any desired point about the page. Moreover, because the invisible control indicia do not effect the appearance of the page, large indicia may be employed to facilitate visual recognition or barcode reading as the case may be.

As indicated above, barcodes are conveniently employed although optical character recognition devices may also be used in conjunction with appropriate indicia.

The inks utilized for imprinting the text and the visible control indicia can be of any suitable type. The ink employed to provide the invisible control indicia can be one which is activated by light in the ultraviolet range or by light in the infrared range. Moreover, the ink may be one which fluoresces when exposed to light of an actuating wavelength.

The specific embodiment described has been one which concentrates on replicating the control indicia in invisible ink to provide the desired verification and control by reading the control indicia.

Moreover, the computer may include in the invisible control indicia other data for controlling subsequent processing such as the folding and assembling functions, stuffing, etc.

As indicated above, the side margins of the web can be perforated to permit engagement by pins or teeth on suitable drive sprockets of the like.

In addition, the invisible ink printing may also provide identification marks for determining counterfeits created by photocopying pages which are genuine.

After the pages have been cut and trimmed, the assembled pages may be folded and prepared for insertion into envelopes.

The invisible control indicia may control automated inserting process such as controlling activation of programmable individual insertion feeders to that different inserts can be added to the documents which are customizable for each document. The invisible indicia can be used to perform a database look up to add targeted print information to the document or other associated documents (such as envelope to enclose coupon) with personalized data, maps, logos, return addresses. Reading and decoding of the invisible indicia and performing a database look up to find the name and address to print on the outside of an envelope associated with the document. Reading and decoding of the invisible indicia may perform a database/computer look up to personalize an attachment (such as membership card) with membership identification and name. After printing and mailing of the documents, the invisible indicia (when containing a database link to a customer or recipient information) can be read after the piece goes through the mail and the customer returns the mailing piece (e.g., customer) to the offerer so that it can be used for accurate tracking and response measurement.

Reading and coding of information during postal sorting processes to trigger equipment functions as separating mail streams for gathering into separate mail trays. Reading and coding of information to trigger the operating of bindery equipment such as using automation to match the cover of a book or magazine with the contents of the magazine (which were printed and collated separately) to ensure accuracy. This is especially important for print-on-demand applications where each book or magazine may have customized covers and customized contents. Reading and coding of information to look up the delivery and supply chain information so that a final user can determine the wholesale and retail channels that were intended for each individual piece. Tracing production related information such as having embedded information of production equipment that produced the piece, job number, equipment operator, and other information that can add information to enhance evaluation of production processes.

Thus, it can be seen from the foregoing detailed description and attached drawings that the method and apparatus of the present invention enables the printing of documents without visible bar codes and with invisible control indicia which may be readily activating for scanning and verification or processing.

Having thus described the invention, what is claimed is:

1. In a method for imprinting documents, the steps comprising:
(a) imprinting visible printed matter on multiple pages of imprintable material, said printed matter being bounded by marginal portions of said pages, and said imprinting including visible control indicia in one of said marginal portions;
(b) optically scanning said visible control indicia and transmitting the data to a computer;
(c) imprinting on said pages in invisible ink invisible control indicia associated with said visible control indicia;
(d) applying an energy source to said invisible control indicia to render said control indicia discernable to a scanner;
(e) scanning said discernable control indicia to generate and transmit scanned data to a computer;
(f) comparing the transmitted data from the discernable control indicia with information stored in said computer to determine that said pages conform to stored parameters;
(g) trimming a marginal portion of said pages to remove the visible control indicia while retaining the invisible control indicia; and
(h) conducting further operations on said pages in which the invisible control indicia are activated by an energy source, scanned, and, based upon the scanned data, the pages are subjected to additional processing steps.

2. The method of imprinting documents in accordance with claim 1 wherein said imprintable material is a continuous web dimensioned to provide a multiplicity of pages across the web and wherein said web is cut into individual pages.

3. The method of imprinting documents in accordance with claim 2 wherein said cutting step is concurrent with said trimming step.

4. The method of imprinting documents in accordance with claim 1 wherein said imprintable material is paper.

5. The method of imprinting documents in accordance with claim 1 wherein said invisible control indicia include additional data for use in subsequent processing of the pages.

6. The method of imprinting documents in accordance with claim 1 wherein, during the additional processing, the step of scanning of the invisible control indicia during subsequent processing to control processing of the pages and ensure compliance with desired quality control parameters.

7. The method of imprinting documents in accordance with claim 1 wherein said energy source is ultraviolet light and wherein said ink is rendered discernable thereby.

8. The method of imprinting documents in accordance with claim 1 wherein said energy source is infrared light and wherein said ink is rendered discernable thereby.

9. The method of imprinting and assembling multiple page documents in accordance with claim 1 wherein there is included additional data in said invisible control indicia.

10. The method of imprinting documents in accordance with claim 1 wherein the initial printing step prints registration marks in said marginal portions to actuate the scanner when the control indicia are positioned thereunder.

11. The method of imprinting documents in accordance with claim 2 wherein said cut pages are collated into multipage documents.

12. Apparatus for printing documents with the printed matter comprising:
(a) a printer for imprinting visible printed matter on the pages of said imprintable material, said printed matter on each page being bounded by marginal portions, said printer printing visible control indicia in a marginal portion of said pages;
(b) a scanner for scanning said visible control indicia and transmitting data from said scanned indicia to a computer;
(c) a printer for imprinting at least some of said pages with invisible control indicia associated with said visible control indicia;
(d) an energy source for rendering said invisible control indicia discernable;
(e) a scanner for scanning said discernable control data and comparing the data with data stored in a computer to ensure that the pages conform to stored parameters;
(f) a cutter station for trimming to remove the marginal portion including said visible control indicia;
(g) an assembler station for gathering said printed pages;
(h) an energy source to render discernable the invisible control indicia;
(i) a scanner for scanning the visible control indicia made discernable by the energy source and transmitting the scanned data;
(j) a computer for receiving the scanned data with computer data stored therein, said computer then effecting operation of subsequent actions or processing stations.

13. The printing apparatus in accordance with claim 12 wherein the cut pages are segregated and moved in multiple paths to an assembling station which assembles the cut pages are collated into multipage documents in accordance with instructions from the computer.

14. The printing apparatus in accordance with claim 12 wherein the energy source is ultraviolet light.

15. The printing apparatus in accordance with claim 12 wherein the energy source is infrared light.

16. The printing apparatus in accordance with claim 12 wherein a collated multipage document is checked for compliance with stored criteria.

17. The printing apparatus in accordance with claim 12 wherein there is included conveying means for conveying the pages from station to station.
